(19) United States
(12) Patent Application Publication
(10) Pub. No.: US 2013/0344406 A1
(43) Pub. Date: Dec. 26, 2013

(54) RECIRCULATING LOOP FOR A FUEL CELL

(71) Applicant: Gino Paganelli, Cottens (CH)

(72) Inventor: Gino Paganelli, Cottens (CH)

(21) Appl. No.: 13/981,545

(22) PCT Filed: Jan. 26, 2012
(86) PCT No.: PCT/EP2012/051197

§ 371 Date: Sep. 9, 2013

(30) Foreign Application Priority Data
Feb. 1, 2011 (FR) 1150749

(51) Int. Cl. H01M 8/04

(52) U.S. Cl. CPC H01M 8/04097
USPC 429/414; 429/415

(57) ABSTRACT

Recycling loop for a gas circuit of a fuel cell stack, forming a connecting line beginning at the outlet of one of the two anode or cathode circuits and terminating in one of the two supply circuits, either in the fuel gas supply channel, or in the oxidant gas supply channel, providing the recycling of the gas contained in the anode or cathode circuits of the fuel cell stack, and comprising a pump that provides the recycling of the gas contained in the anode or cathode circuits of the fuel cell stack, a multi-way valve dividing said recycling loop into a first section and a second section, said multi-way valve having a first stable usage position providing the continuity between the first and second sections of said recycling loop and having a second stable usage position simultaneously providing the interruption of said continuity between the first and second sections of said recycling loop and a bringing of said recycling loop into contact with the atmosphere carried out by manoeuvring said multi-way valve.

### BACKGROUND

1. Field

Disclosed herein is a recycling loop and methods that relate to fuel cell stacks, in particular, but not exclusively, to fuel cell stacks of the type having an electrolyte in the form of a polymer membrane (i.e. of PEFC (Polymer Electrolyte Fuel Cell) type).

2. Description of Related Art

It is known that fuel cell stacks enable electrical energy to be produced directly via an electrochemical redox reaction starting from hydrogen (the fuel) and oxygen (the oxidant), without passing via a mechanical energy conversion step. This technology seems promising, especially for motor vehicle applications. A fuel cell stack comprises in general the series combination of unitary components each consisting essentially of an anode and a cathode separated by a polymer membrane enabling ions to pass from the anode to the cathode.

In the case of “dead end” circuits, i.e. circuits that do not normally open into the ambient surroundings, which is generally the case for the anode circuit, and also the case for the cathode circuit for cells operating with pure oxygen, the recycling of the gases contained in the anode or cathode circuits of the fuel cell stack during normal operation is necessary so as to achieve a necessary oversupplying of the anode or cathode circuits without overconsumption of gas and also to wet the incoming fresh gas by virtue of the water contained in the recirculated gas.

Patent application WO 06/012953 and patent application EP 2 017 916 describe a fuel cell stack, in particular the gas supply channel thereof. In certain fuel cell stack uses, one is lead to increase the number of fluid pumps and/or compressors both at the anode circuit and at the cathode circuit, in order to be able to carry out quite sophisticated gas circuit controls, more particularly during the shutdown phases of a fuel cell stack. Reference may be made, for example, to patent application FR 2009/57644.

### SUMMARY

The objective of the embodiment of the present invention is to succeed in providing a sophisticated control of the gas recycling and purges or venting to the atmosphere that are necessary, whether operating in start-up or extinction phase or regime, without increasing the pumps, which are relatively bulky and expensive devices.

Disclosed herein is a recycling loop for a gas circuit of a fuel cell stack, the recycling loop forming a connecting line beginning at the outlet of one of the two anode or cathode circuits of said fuel cell stack and terminating in one of the two supply circuits, either in the fuel gas supply channel, or in the oxidant gas supply channel respectively, said recycling loop providing the recycling of the gas contained in the anode or cathode circuits of the fuel cell stack, said recycling loop comprising a recirculating pump that provides the recycling of the gas contained in the anode or cathode circuits of the fuel cell stack, characterized in that the recycling loop comprises a multi-way valve dividing said recycling loop into a first section and a second section, said multi-way valve having a first stable usage position, referred to as recycling position, providing the continuity between the first and second sections of said recycling loop and having a second stable usage position simultaneously providing the interruption of said continuity between the first and second sections of said recycling loop and a bringing of said recycling loop into contact with the atmosphere carried out by manoeuvring said multi-way valve.

In one preferred embodiment of the invention, the multi-way valve is a three-way valve. In the remainder of the description, examples using such a valve will be described. However, the present invention does not exclude the use of other types of valves, for example an arrangement of two two-way valves instead of one three-way valve, or any other arrangement of one or more multi-way valves.

In one particular embodiment of the invention, the pump installed in the recycling loop is capable of providing the recycling of the gas contained in the anode or cathode circuits of the fuel cell stack when the valve is in a first position, and is capable of providing the extraction or injection of gas when the valve is in a second position.

Embodiments disclosed herein make it possible to use a single pump for carrying out the recycling functions in normal operation of the fuel cell stack and the function of extracting fuel gas during particular operating phases such as a shutdown cycle of the fuel cell stack. This arrangement applies, on the anode circuit side, equally to cells supplied with atmospheric air as oxidant gas and to cells supplied with oxygen for the cathode side. The embodiments relate both to cells supplied with pure oxygen for the cathode side, but also to cells supplied with atmospheric air for this cathode side.

Embodiments disclosed herein make it possible to use a single pump for carrying out the mixing function for homogenization of the gas in the cathode circuit, and also the air injection function during particular operating phases such as a shutdown cycle of the fuel cell stack. This arrangement applies, on the cathode circuit side, equally to cells supplied with atmospheric air as oxidant gas and to cells supplied with pure oxygen. Moreover, in the case of cells supplied with pure oxygen, for the cathode circuit, the same pump provides, in addition, the recycling function in normal operation of the cell.

Also disclosed herein is a particular procedure for shutting down a fuel cell stack comprising the features described above, the shutdown procedure comprising the following actions:

(i) cutting off the supply of fuel gas and oxidant gas,

(ii) positioning the three-way valve of each of the two anode or cathode circuits in sequence in the following successive positions:
in a position that makes it possible to carry out, at the cathode circuit, the air injection function by controlling the pump in an appropriate manner, and that makes it possible to carry out, at the anode circuit, the hydrogen drainage function by controlling the pump in an appropriate manner,
in a position that makes it possible to carry out, at each of the two anode and cathode circuits, the gas recycling or mixing function by controlling each of the pumps in an appropriate manner.

### BRIEF DESCRIPTION OF THE DRAWINGS

The remainder of the description serves to make all the aspects of the invention clearly understood by means of the appended drawings in which:

FIG. 1 is a diagram of a fuel cell stack according to an embodiment of the invention, supplied with pure oxygen;

FIG. 2 is a diagram of a fuel cell stack according to an embodiment of the invention, supplied with ambient air;

FIG. 3 is a diagram of an embodiment variant of a fuel cell stack according to invention, supplied with ambient air;

FIG. 4 shows the variation of various parameters during the extinction of a fuel cell stack as illustrated in FIG. 1;

FIG. 5 shows a flow chart of an embodiment of the procedure for shutting down a fuel cell stack according to the invention.

### DETAILED DESCRIPTION OF SPECIFIC EMBODIMENTS

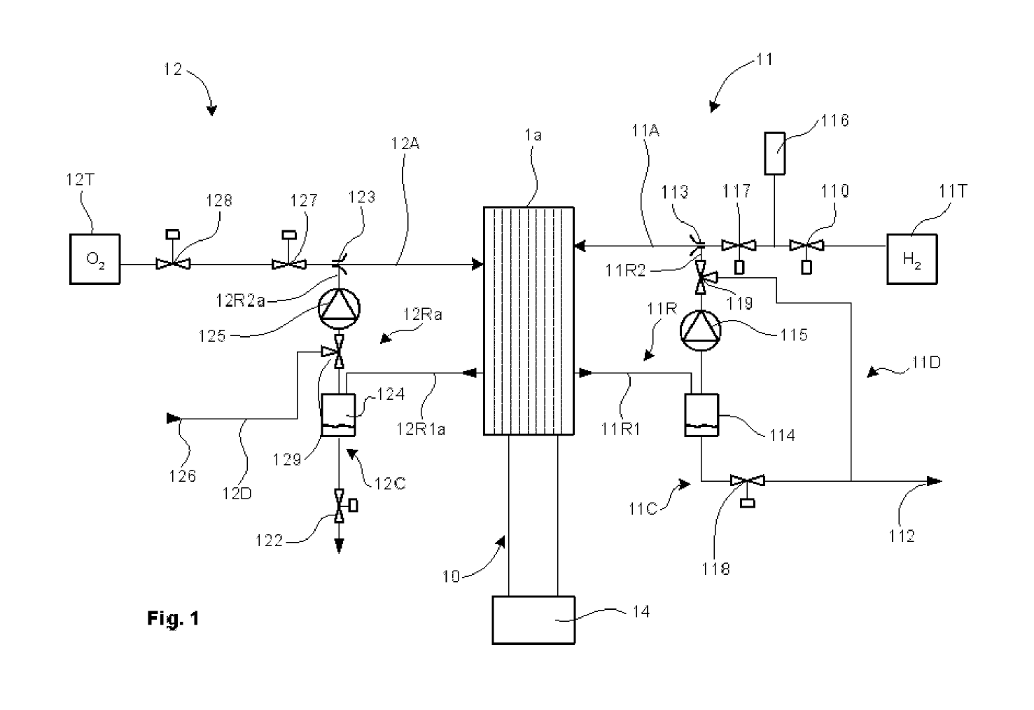

FIG. 1 shows a fuel cell stack 1a of the type having an electrolyte in the form of a polymer membrane (i.e. of PEFC (Polymer Electrolyte Fuel Cell) or PEM (Proton Exchange Membrane) type). The fuel cell stack 1a is supplied with two gases, namely the fuel (hydrogen stored or generated on board the vehicle) and the oxidant (in this example, pure oxygen), which gases supply the electrodes of the electrochemical cells. An electrical load 14 is connected to the fuel cell stack 1a via an electrical line 10. To simplify matters, FIG. 1 shows only the gas circuit components useful for understanding the invention.

### Description of the Anode Circuit

The installation illustrated in FIG. 1 comprises a fuel gas supply circuit 11 on the anode side. A pure hydrogen (H₂) tank 11T is visible, this being connected to the inlet of the anode circuit of the fuel cell stack 1 by means of a supply line that passes via a cut-off valve 110, then via a pressure regulating valve 117, then via an ejector 113 and then via a fuel gas supply channel 11A terminating at the anodes. In the case of a high-pressure storage, a pressure-reducing valve (not represented) is placed between the tank 11T and the cut-off valve 110. Forming part of the hydrogen (fuel) supply circuit 11 is a loop 11R for recycling the hydrogen not consumed by the fuel cell stack, connected to the outlet of the anode circuit of the fuel cell stack 1a.

The recycling loop 11R forms a connecting line beginning at the outlet of the anode circuit of the fuel cell stack 1a and terminating in the fuel gas supply channel 11A at the ejector 113. The ejector 113 provides the recycling of the fuel gas not consumed by the fuel cell stack and the mixing with fresh fuel gas originating from the pure hydrogen (H₂) tank 11T. The recycling loop comprises a pump 115 providing a forced and controlled recycling of the gas not consumed by the fuel cell stack. The recycling loop comprises a three-way valve 119 dividing said recycling loop 11R into a first section 11R1 and a second section 11R2.

By positioning the three-way valve 119 at its first position (recycling position), the pump 115 is used for the function of recirculating the fraction of a fuel gas not consumed when crossing the anode circuit of the fuel cell stack.

During the shutdown of the fuel cell stack, one may be driven to have to extract the hydrogen forcibly from the anode circuit. In this case, by positioning the three-way valve 119 in its second position, the interruption of the communication of the recycling loop to the ejector 113 is provided. The first section 11R1 is isolated from the second section 11R2 of the recycling loop 11R. The first section 11R1 is then brought into contact with the atmosphere, via a first purge line 11D which terminates in an orifice 112 for venting to the atmosphere. In this case, the pump 115 is used for the function of extracting fuel gas during a shutdown phase of the fuel cell stack.

It should also be noted that the recycling loop 11R comprises a water separator 114, installed in the first section 11R1 of the recycling loop 11R. A second purge line 11C is installed beneath the water separator 114. A cut-off valve 118 is installed in this second purge line 11C. The latter terminates at the same orifice 112 for venting to the atmosphere. By controlling the cut-off valve 118, it is possible to provide the two-fold function of draining the water separator 114 and of purging the anode circuit when this is necessary.

An additional fuel gas accumulation chamber 116 is also visible, this being placed in the piping of the fuel gas supply circuit 11, between the cut-off valve 110 and a pressure regulating valve 117.

It should be noted that the additional fuel gas accumulation chamber 116 could be placed at any point in the fuel gas supply circuit, that is to say at any point between the cut-off valve 110 and the fuel cell stack 1, even in the recycling circuit 11R or in the circuit between the water separator 114 and the ejector 113. However, it is advantageous to place it at a point in the circuit where the pressure is higher, so as to reduce the volume thereof or, at an identical volume, so as to store a greater quantity of hydrogen. Moreover, the position upstream of the pressure regulating valve makes controlled discharge from said accumulation chamber possible.

### Description of the Cathode Circuit

It will now be described how it is possible to implement the invention at the cathode circuit of a fuel cell stack.

The installation illustrated in FIG. 1 comprises a pure oxygen supply circuit 12, pure oxygen being used as the oxidant gas. A pure oxygen (O₂) tank 12T is visible, this being connected to the inlet of the cathode circuit of the fuel cell stack 1a by means of a supply line 12A that passes via a cut-off valve 128, then via a pressure regulating valve 127, then via an ejector 123, and terminates at the cathodes of the fuel cell stack. In the case of a high-pressure storage, a pressure-reducing valve (not represented) is placed between the tank 12T and the cut-off valve 128. Forming part of the oxygen supply channel 12 is a loop 12Ra for recycling the gas contained in the cathode circuit of the fuel cell stack 1a, connected to the outlet of the cathode circuit of the fuel cell stack 1a. The recycling loop 12Ra comprises a three-way valve 129 dividing said recycling loop 12Ra into a first section 12R1a and a second section 12R2a. A water separator 124 is installed in the recycling loop 12Ra, in the first section 12R1a of the recycling loop 12Ra upstream of the three-way valve 129. A purge line 12C is connected beneath the water separator. This purge line 12C terminates at a cut-off valve 122 that is manoeuvred when it is necessary to purge the cathode circuit or to drain the separator 124.

The recycling loop 12Ra forms a connecting line beginning at the outlet of the cathode circuit of the fuel cell stack 1a and terminating in the oxygen supply channel 12A at the ejector 123. The ejector 123 provides the recycling of the oxygen not consumed and the mixing with fresh oxygen originating from the tank. The recycling loop 12Ra comprises a pump 125. An air supply channel 12D, beginning at an orifice 126 for venting to the atmosphere, is connected to the three-way valve 129.

By positioning the three-way valve 129 at its first position, it has been indicated that the continuity between the first section 12R1a and the second section 12R2a of said recycling loop 12Ra is provided. In this case, the pump 125 is used for the function of recirculating the gas contained in the cathode circuit of the fuel cell stack.

In certain operating phases of the cell, for example during a shutdown, it is possible to be driven to have to forcibly inject atmospheric air into the cathode circuit. In this case, by positioning the three-way valve 129 at its second position, the interruption of the communication from the recycling loop to the ejector 123 is provided. The first section 12R1a is isolated from the second section 12R2a of the recycling loop 12Ra. The second section 12R2a is then brought into contact with the atmosphere, via the pump 125 and the air supply line 12D. In this case, the pump 125 is used for the function of injecting air.

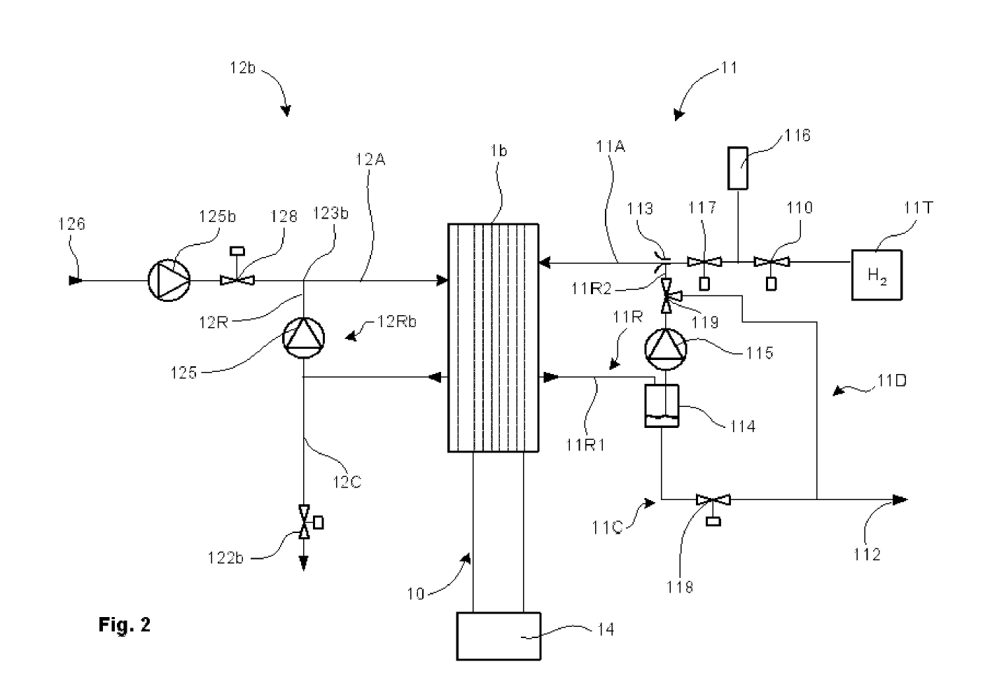

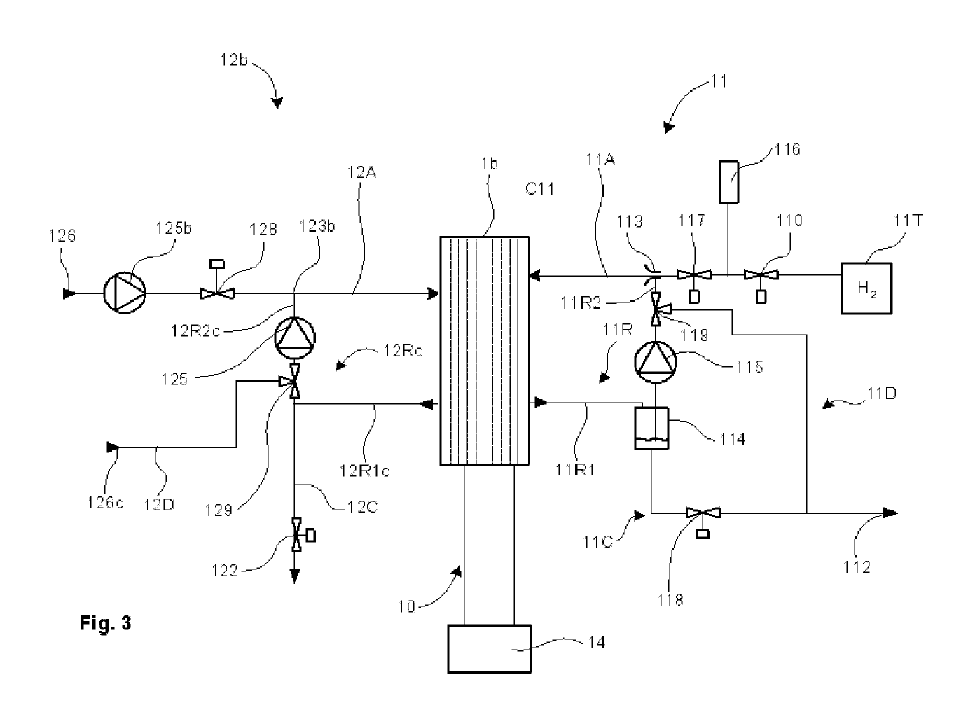

It should be emphasized that the invention, at the cathode circuit, may be applied both to fuel cells supplied with pure oxygen and to fuel cells supplied with atmospheric air as the oxidant gas. The implementation variants for fuel cells operating using atmospheric air as the oxidant gas will be examined below, based on FIGS. 2 and 3.

### Variations for Other Implementations of the Invention

For cells using atmospheric air, in the cathode circuit 12b, it should be noted that there is no recycling to the cathode during the normal operation of the cell. Specifically, since the unconsumed gas is so poor in oxygen (depleted air), it is not advisable to recycle it. A recycling operation is used at the cathode only during the extinction of the fuel cell stack, not for mixing the unconsumed gas with fresh gas but solely for homogenizing, via mixing, the gas contained at the cathode so as to achieve a complete consumption of the oxygen without the risk of a locally higher oxygen concentration.

FIG. 2 therefore illustrates an implementation of the invention for a fuel cell stack 1b supplied with atmospheric air. It is seen that in this case, the specific elements of the present invention are installed in an identical manner to FIG. 1 on the anode circuit side. Visible in the cathode circuit is an air compressor 125b used, in normal operation, for supplying the fuel cell stack with atmospheric air. Another difference is that the recycling circuit 12Rb for the cathode gas is directly connected to the supply channel 12A without passing through an ejector, by a simple branch connection 123b downstream of the air compressor 125b. A pressure regulating valve 122b enables, in normal operation, depleted air to continuously escape to the atmosphere. The degree of opening of this pressure regulating valve 122b is controlled in order to maintain the pressure at the desired value in the cathode circuit.

In normal operation of the fuel cell stack, the recycling circuit is not used, the pump 125 is shutdown, and no gas circulates in the recycling circuit 12Rb which becomes virtually non-existent. All of the gas not consumed by the cathode circuit is vented to the atmosphere through the pressure regulating valve 122b. If the pump 125 does not naturally provide the non-return function when it is stopped, it is necessary to provide a non-return valve in the recycling circuit 12Rb so as to guarantee the passage of all of the air supplied by the compressor to the cathode circuit of the fuel cell stack 1b.

The cut-off valve 128 makes it possible to isolate the cathode circuit from the atmospheric air when the cell is shutdown. This cut-off valve 128 may either be placed upstream or downstream of the compressor.

Represented in FIG. 3 is an embodiment variant of a fuel cell stack 1b supplied with atmospheric air, in which the recycling loop 12Rc of the cathode circuit comprises a three-way valve 129 just like in the embodiment illustrated in FIG. 1. The recycling loop 12Rc also comprises a pump 125. The three-way valve 129 divides the recycling loop 12Rc into a first section 12R1c and a second section 12R2c. An air supply line 12D, beginning at another orifice 126c for venting to the atmosphere, is connected to the three-way valve 129.

By positioning the three-way valve 129 at its first position, just like in the first variant described above, the pump 125 is used for the function of recirculating the cathode gas of the fuel cell stack. When it is desired to forcibly inject atmospheric air into the cathode circuit, when carrying out an extinction procedure thereof, by positioning the three-way valve 129 at its second position, the interruption of the communication from the recycling loop to the connection 123b and the bringing of the second section 12R2c into contact with the atmosphere, via the pump 125 and the air supply line 12D, are simultaneously provided. In this case, the pump 125 is used for the function of injecting air.

The other elements that appear in FIG. 3 have an identical role to what was described above.

This variant is particularly useful if, as is generally done so, the compressor 125b is supplied with electrical energy directly by the fuel cell stack itself. Indeed, during the start-up and shutdown phases, the voltage over the fuel cell stack is not sufficient to supply the compressor 125b. Furthermore, the size of the pump 125 is much less than that of the compressor 125b. It is then advantageous to have another means of injecting air in order to initiate the start-up of the cell or in order to inject the air needed (in a small amount) for the generation of nitrogen during the extinction of the cell. The pump 125 is in general supplied by a low-voltage source that is always available even when the fuel cell stack is shutdown. For all of these reasons (available electrical voltage, amount of air to be injected) it is preferable to use the pump 125 for introducing air during the shutdown phase.

### Description of the Extinction Procedure

The procedure described below makes it possible to extinguish the fuel cell stack so as to guarantee storage with a hydrogen/nitrogen mixture therein, without requiring a nitrogen tank.

The shutdown procedure is essentially composed of the following phases:

1^{st} phase: residual oxygen consumption phase, which occurs upon cutting off the fuel gas supply and oxidant gas supply, and by drawing a current I_{S} at the terminals of the fuel cell stack. This current draw I_{S} is maintained as long as an appropriate indicator indicates that the oxidant gas in the oxidant gas supply system has not been sufficiently consumed. An appropriate indicator is for example the voltage across the terminals of the fuel cell stack;

2^{nd} phase: neutralization phase that occurs when filling the cathode circuit with nitrogen. In the embodiment described here, the nitrogen is that of the atmospheric air. Forced injection of atmospheric air then takes place, thereby again introducing a little oxygen, the consumption of which must be controlled by the current draw; and

3^{rd} phase: forced extraction phase during which, after the electrochemical processes have been completely shut down, any excess fuel gas is forcibly removed (here, forced extraction of the excess hydrogen). It should be emphasized that, by virtue of the invention, this extraction takes place only after the fuel cell stack has been brought into a state in which the precautions for avoiding insufficient supply of hydrogen, the serious consequences of which are known, have been taken.

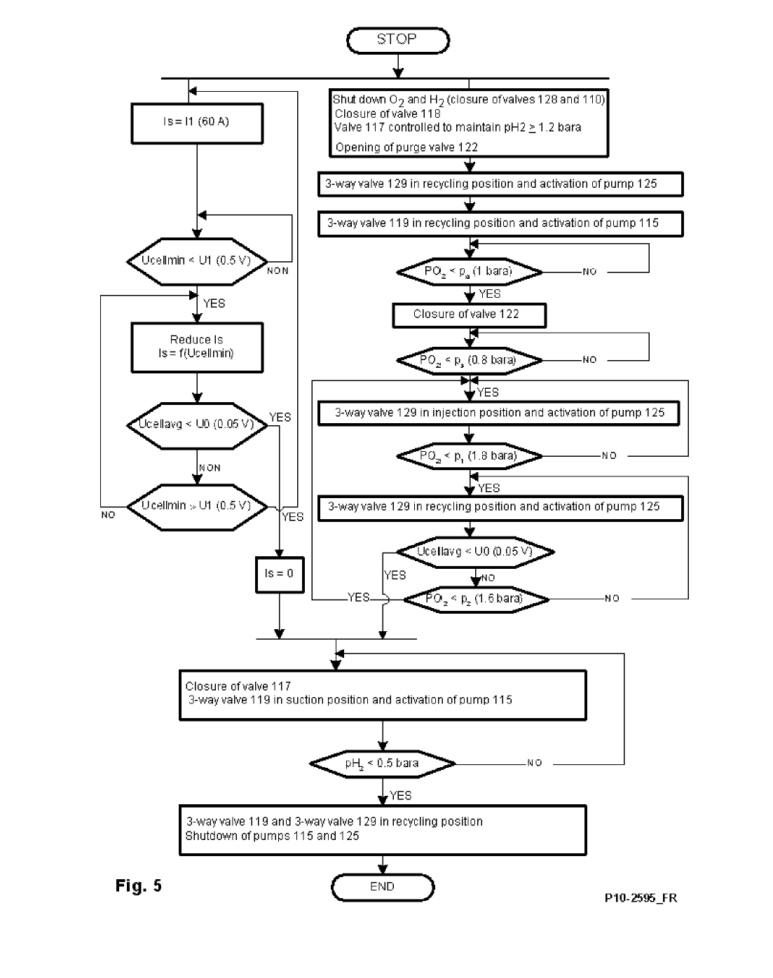

FIG. 5 schematically shows an example of the sequence of the essential commands of the shutdown procedure according to the invention. Other command methods are possible without departing from the scope of the invention. It can be seen that, after an order to shut down the fuel cell stack (STOP instruction), an automatic fuel cell stack controller starts the shutdown procedure by cutting off the supply of gases, that is to say by closing, for example simultaneously, the cut-off valves 110 and 128.

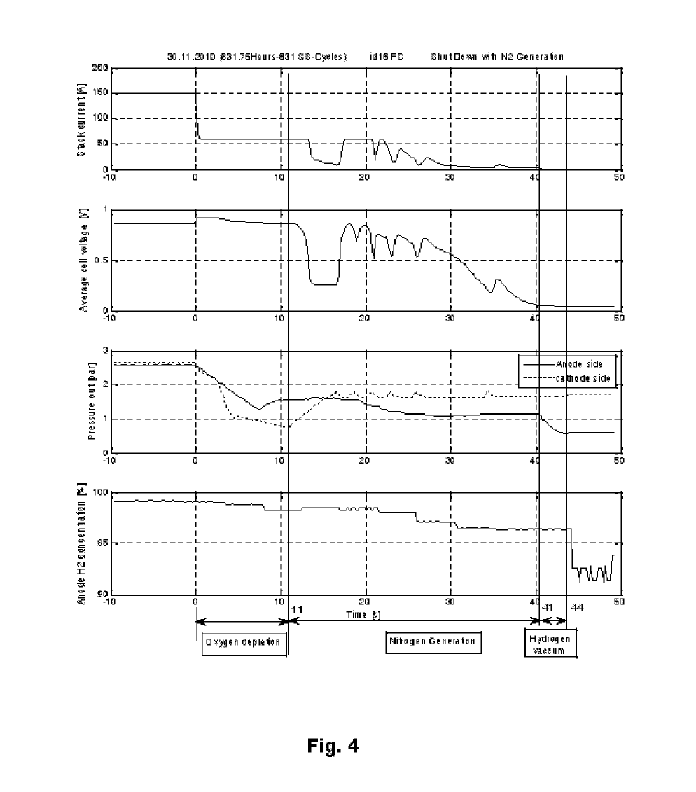

FIG. 4 illustrates the sequence of the three phases during a shutdown actually measured on a fuel cell stack comprising 20 cells having an active area of 300 cm², operating with pure oxygen, in accordance with the arrangement illustrated in FIG. 1. The x-axis indicates the time in seconds, with as reference (0) the instant when the shutdown procedure starts. This figure shows the variation of the following quantities as a function of time during a shutdown with nitrogen generation:

curve 1, the y-axis of which is labelled “Stack current [A]”, showing the current drawn from the fuel cell stack, expressed in amps;

curve 2, the y-axis of which is labelled “Average cell voltage [V]” showing the average electrical voltage across the terminals of the cells of the fuel cell stack, expressed in volts;

curve 3, the y-axis of which is labelled “Pressure out [bar]”, showing the pressure within the anode compartment (hydrogen: solid line) and in the cathode compartment (oxygen: dotted line), expressed in bara (as is usual in the field of fuel cell stacks, “mbara” means “millibar absolute”, the final letter “a” denoting “absolute”); and

curve 4, the y-axis of which is labelled “Anode H2 concentration [%]”, showing the hydrogen concentration in the anode compartment, expressed in vol %.

During the first phase of the extinction (0 to 11 s, marked “Oxygen depletion” in FIG. 4), starting from the moment when the oxygen supply is cut off (by closing the cut-off valve 128, at the same instant that the cut-off valve 110 is closed, cutting off the hydrogen supply, see the first block of the right-hand branch from FIG. 5), the residual pure oxygen in the fuel cell stack is first partially vented to atmosphere via the momentary opening of the purge valve 122.

Subsequently, the rest is consumed by drawing a current I_{S} during a neutralization phase which will be explained below. The purge valve 122 remains closed during the rest of the extinction procedure and also during rest, so as to prevent air from penetrating the cathode.

As the first curve from FIG. 4 and the start of the left-hand branch from FIG. 5 illustrate, the current I_{S} is firstly established at 60 A. From the moment that at least one cell drops below the threshold of 0.5 V (see test on Ucellmin in the left-hand branch), the controller progressively reduces the current I_{S} (see “reduce Is” in the left-hand branch from FIG. 5); shortly afterwards the fuel cell stack starts to drop in voltage. It is advisable to equip the fuel cell stack with sensors and electrical connections necessary for individually monitoring the voltage of the cells making up the stack, at least certain cells of the fuel cell stack. From the moment that the pressure p at the cathode circuit of the fuel cell stack is below an experimentally chosen threshold value p_{S} (see the test on the oxygen pressure in the right-hand branch from FIG. 5, here, 0.8 bara, occurring approximately after 11 seconds as shown in FIG. 4), the neutralization phase begins (11 to 41 s, marked “Nitrogen Generation” in FIG. 4).

During the neutralization phase, the recycling and the air injection cannot be simultaneous. Depending on the position of the three-way valve, there is either recycling (first position), or injection (second position). This alternation in the controlling of the extinction clearly appears in the second part of the right-hand branch of FIG. 5, which shows that the three-way valve is firstly in injection position (second position) as long as the pressure in the cathode circuit remains below the threshold of 1.8 bara and then which shows that the three-way valve is subsequently in recycling position (first position) and maintains the recycling as long as the pressure in the cathode circuit remains above the threshold of 1.6 bara and returns to an injection phase as soon as the pressure in the cathode circuit passes the threshold of 1.6 bara. The result of this is an extinction in stages, each of these stages being the alternation of an injection and of a recycling. As soon as the average voltage of the cells is substantially zero, a sign of almost complete oxygen depletion, the neutralization phase is terminated, as shown by the output “yes” of the test on Ucellavg from the right-hand branch of FIG. 5.

Furthermore, during the “nitrogen generation” phase, the pump 125 alternately provides the recycling function and the air injection function. These alternations of function result in pressure waves measured at the cathodes and in voltage waves measured in the cells. It should be noted that the cathode pressure waves and cell voltage waves are in phase opposition (see respectively the third curve and second curve from FIG. 4). This is because during the air injection phases (three-way valve in position enabling the injection function to be carried out), the pressure at the cathode increases, but since the recycling function is not provided during this time, the cathode gas is no longer mixed giving rise to a local shortage of oxygen in the cathode channels which is expressed by a drop in the voltage. Conversely, when the pump provides the recycling function (three-way valve in recycling position), the cathode gas is mixed and the cathode channels are again better supplied with oxygen, which is expressed by an increase in the cell voltages, but as there is no longer any injected air, the oxygen consumption gives rise to a drop in the pressure at the cathode.

The repeated air injections result in a voltage rise that is less and less high, to the extent that the presence of nitrogen in the cathode circuit becomes increasingly dominant. In the example illustrated here, with the aid of the curves from FIG. 4, the first injection of air begins at the time 11 s when the pressure at the cathode drops to 0.8 bara and is maintained until the pressure at the cathode reaches 1.8 bara. The three-way valve 129 is ordered to the air injection position at the same time as the pump 125 is activated so as to pressurize the cathode circuit to a pressure which increases gradually, then the three-way valve 129 is ordered to the recycling position at the same time as the pump 125 is controlled in an appropriate manner. The pressure of the cathode circuit thus oscillates between 1.8 bara and 1.6 bara, this average level being achieved at around 15 s.

The current draw I_{S} is firstly established at a first constant level (around 60 amps) then it is reduced in proportion to the lowest of the voltages of the cells of the fuel cell stack. Conversely, it is seen in FIG. 4 that the intensity of the current drawn rises again somewhat, concomitantly with each new rise in voltage. The control of the current draw is seen in the second part (see “reduce Is”) of the left-hand branch of FIG. 5, as a function of tests on the voltage of the fuel cell stack). The current finally becomes zero when the voltage of the fuel cell stack approaches 0 V, as shown by the output “yes” of the second test on the voltage of the fuel cell stack from the left-hand branch of FIG. 5.

The third curve of FIG. 4 indicates that the pressure in the cathode compartment drops to less than 1000 mbara. On the other hand, despite the consumption associated with the current production, the hydrogen pressure still remains above 1.1 bara until the extraction phase owing to the presence of the additional fuel gas accumulation chamber 116.

From the start of the extinction procedure and up to the time 41 s, the pump 115 on the anode side is kept in operation and the three-way valve 119 in the recycling position so as to mix the anode gas and prevents any local shortage of hydrogen. Throughout the entire duration of the extinction, the shortage of hydrogen is avoided, as indicated by the hydrogen concentration represented in the fourth curve of FIG. 4, which shows that the volume concentration of hydrogen remains greater than 90% in the anode circuit throughout the entire duration of the extinction procedure.

At the time 41 s, the hydrogen extraction phase is ordered by placing the three-way valve 119 in the extraction position (second position, see second to last block from FIG. 5) making it possible to extract fuel gas by activating the pump 115 as long as the pressure in the anode circuit is not below the threshold of 0.5 bara. Finally, when the pressure in the anode circuit is below said threshold of 0.5 bara, the shutdown procedure finishes with the shutting down of the pumps 115 and 125 and the positioning of the three-way valves 119 and 129 in the recycling position (first position).

In this example, after six (6) alternations of air injections/recirculation, the cathode is essentially filled with nitrogen, and the voltage of the cells is virtually zero. This is only one example of a method for controlling the alternation of air injections/recirculation; other control methods resulting in an alternation of air injections/recirculation are possible.

1. A recycling loop for a gas circuit of a fuel cell stack, wherein the recycling loop:
forms a connecting line beginning at the outlet of one of the two anode or cathode circuits of said fuel cell stack and terminating in one of the two supply circuits, either in a fuel gas supply channel, or in an oxidant gas supply channel, and
provides the recycling of the gas contained in the anode or cathode circuits of the fuel cell stack,
said recycling loop comprising:
a pump that provides the recycling of the gas contained in the anode or cathode circuits of the fuel cell stack,
a multi-way valve dividing said recycling loop into a first section and a second section, said multi-way valve having:
a first stable usage position providing the continuity between the first and second sections of said recycling loop, and
a second stable usage position simultaneously providing interruption of said continuity between the first and second sections of said recycling loop and bringing recycling loop into contact with the atmosphere, wherein said first and second stable usage positions are carried out by manoeuvring said multi-way valve.

2. The recycling loop according to claim 1, further comprising a water separator, wherein said pump is installed in the first section, upstream of the multi-way valve and a first purge line connected to the multi-way valve to provide said bringing of said recycling loop into contact with the atmosphere carried out by manoeuvring said multi-way valve.

3. The recycling loop according to claim 2, further comprising a second purge line installed beneath the water separator, wherein said purge lines terminate at one and the same orifice for venting to the atmosphere.

4. The recycling loop according to claim 1, wherein the gas circuit of the fuel cell stack is an oxidant gas circuit, wherein said pump is installed in the second section, downstream of the multi-way valve and further comprising an air supply line connected to the multi-way valve to provide said bringing of said recycling loop into contact with the atmosphere carried out by manoeuvring said multi-way valve.

5. The recycling loop according to claim 4, further comprising a purge line connected to the first section of the recycling loop, upstream of the multi-way valve, said purge line terminating at a cut-off valve.

6. The recycling loop according to claim 1, wherein the multi-way valve is a three-way valve.

7. A process for shutting down a fuel cell stack according claim 1, comprising:
(i) cutting off the supply of fuel gas through the fuel gas supply channel and oxidant gas through the oxidant gas supply channel,
(ii) positioning the multi-way valve of each of the two anode or cathode circuits in sequence in the following successive positions:
a position that makes it possible to carry out, at the cathode circuit, an air injection function by controlling the pump in an appropriate manner, and that makes it possible to carry out, at the anode circuit, a hydrogen drainage function by controlling the pump in an appropriate manner,
a position that makes it possible to carry out, at each of the two anode and cathode circuits, the recycling of gas by controlling each of the pumps in an appropriate manner.
